(19) United States
(12) Patent Application Publication
(10) Pub. No.: US 2026/0323072 A1
(43) Pub. Date: Oct. 15, 2026

(54) INTRA AFFINE PREDICTION IN VIDEO CODING

(71) Applicant: DOLBY LABORATORIES LICENSING CORPORATION, San Francisco, CA (US)

(72) Inventors: Jeeva Raj ARUMUGAM, Rasipuram (IN); Ashwin NATESAN, Bangalore (IN); Vaibhav Pandurang VALVAIKER, Bangalore (IN); Jay Nitin SHINGALA, Bangalore (IN); Fangjun PU, Sunnyvale, CA (US); Taoran LU, Santa Clara, CA (US); Peng YIN, Ithaca, NY (US); Abhijeet Basavaraj SARATE, Solapur (IN)

(73) Assignee: DOLBY LABORATORIES LICENSING CORPORATION, San Francisco, CA (US)

(21) Appl. No.: 19/491,541

(22) PCT Filed: Jun. 26, 2024
(86) PCT No.: PCT/US2024/035660

§ 371 Date: Dec. 9, 2025

(30) Foreign Application Priority Data
Jun. 28, 2023 (IN) 202311043461
Oct. 5, 2023 (IN) 202311066925

(51) Int. Cl. H04N 19/513; H04N 19/176; H04N 19/593

(52) U.S. Cl. CPC H04N 19/513; H04N 19/176; H04N 19/593

(57) ABSTRACT

Methods and systems are described for video coding and decoding using intra affine prediction. Two or three control point best vectors (CPBV) to be used to derive motion vectors of affine predictions are generated based on creating for each CPBV a list of candidate best vectors, and selecting according to a criterion the two or three best ones. Methods to generate the list of the candidate best vectors include a first method based on neighboring coded units and a distance criterion among two consecutive best vectors in the list, and a second method based on template matching between a coded unit to be encoded or decoded and prior-decoded coded units in a reference area.

### CROSS-REFERENCE TO RELATED APPLICATIONS

This patent application claims the benefit of priority from Provisional Indian Patent Application number 202311043461, filed on 28 Jun. 2023, and Provisional Indian Patent Application number 202311066925, filed on 5 Oct. 2023, each of which is incorporated by reference herein in its entirety.

### TECHNOLOGY

The present document relates generally to images and video coding. More particularly, an embodiment of the present invention relates to applications of Intra affine prediction tools in video coding.

### BACKGROUND

In 2020, the MPEG group in the International Standardization Organization (ISO), jointly with the International Telecommunications Union (ITU), released the first version of the Versatile Video Coding Standard (VVC), also known as H.266 (Ref. [1]). More recently, the same group has been working on the development of the next generation coding standard that provides improved coding performance over existing video coding technologies. As part of this investigation, new coding techniques are also examined.

As appreciated by the inventors here, improved techniques for applying Intra affine prediction tools in image and video coding are desired, and they are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts examples of Intra-block copying (IBC) and Affine prediction according to prior art;

FIG. 2 depicts an example of subblock based affine prediction according to prior art;

FIG. 3 depicts an example of motion vector prediction (MVP) in IBC-Affine prediction according to prior art;

FIG. 4 depicts derivation points to derive control point block vectors (CPBV) in advanced intra affine according to an embodiment of this invention;

FIG. 5 depicts subblock-based block vector derivation for the current block in advanced intra affine mode according to an embodiment of this invention;

FIG. 6 depicts examples of templates for using template matching in advanced intra affine mode according to an embodiment of this invention; and

FIG. 7 depicts examples of deriving control point vectors for an intra affine transform using template matching according to an embodiment of this invention;

FIG. 8 depicts examples of deriving control point block vectors (CPBVs) for intra affine transform based on different model types according to an embodiment of this invention;

FIG. 9 depicts an example CPBV list construction process, according to an embodiment of this invention;

FIG. 10 depicts an example of an intra affine candidate list construction process according to an embodiment of this invention; and

FIG. 11 depicts control point intra prediction modes from spatial neighbors to be used for deriving the sub-block modes using an affine model, according to an embodiment of this invention.

### DESCRIPTION OF EXAMPLE EMBODIMENTS

Example embodiments that relate to applying Intra Affine prediction tools in video coding are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to applying intra affine prediction tools in image and video coding. In intra affine prediction, an affine transform is generated based on motion vectors generated from two or three control point best vectors (CPBV). In embodiments described herein the two or three CPBVs are selected from a final intra affine candidate list that includes a combination of generated best vectors (BVs). In a first embodiment, for a coded unit (CU), the BVs are generated based on neighboring CUs that were coded in IBC, intra TMP, or intra affine mode and a distance criterion based on the distance between two consecutive BVs in the candidate list of a specific CPBV. In a second embodiment, the BVs are generated based on minimizing a template matching cost between the CU and candidate CUs in a reference area of the CU. In a third embodiment, a fusion technique reduces encoding complexity of the template matching based method. In a fourth embodiment, intra modes of a subblock in a CU are derived based on control point best vectors of neighboring blocks of the CU.

### Intra Affine Prediction in Video Coding

### Introduction

### Intra Block Copy (IBC)

Intra block copy (IBC) (Ref. [3]) was first proposed in HEVC as a tool to exploit spatial redundancies, especially for screen content. It is particularly effective in areas with text, repeating geometrical patterns, or periodic textures. When IBC is enabled, motion estimation is performed within the reconstructed area in the current frame. The corresponding block of reference samples is used as prediction for the current block, and the corresponding block vector is transmitted in the bitstream. IBC was used in VVC (Ref. [1]) for screen content coding and was further extended to be used for nature content in the enhanced compression model (ECM) software implementation, e.g., ECM 7 or later (Ref. [2]).

### Intra Template Matching Prediction

In ECM (Ref. [2]), Intra template matching prediction (Intra TMP) is a special intra prediction mode that copies the best prediction block from the reconstructed part of the current frame, that is, the block whose L-shaped template matches best (according to some quality criterion, like sum of absolute differences (SAD)) the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### Affine Transform for Intra Prediction

Conventional coding tools such as IBC and Intra TMP which directly copy from neighboring pixels may not accurately predict geometrical transformations such as transitions, rotations, zooms, and the like. In Ref. [4], the authors proposed an affine intra prediction algorithm by extending the functionalities of IBC for screen content.

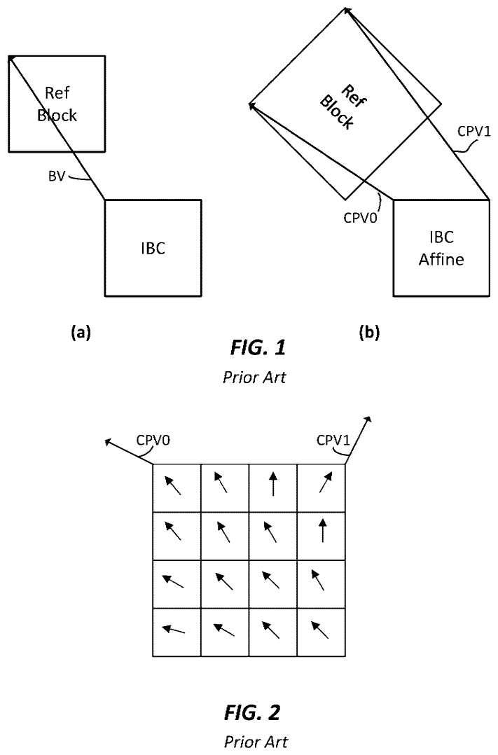

In conventional IBC, as illustrated in FIG. 1 (a), a block vector (BV) is used to locate the top-left corner of the reference block to predict the current block. In Ref. [4], as illustrated in FIG. 1 (b), the authors proposed to extend the IBC mode to include affine transformation.

An affine transformation is typically represented by a zoom factor ρ, rotation angle θ, and horizontal and vertical displacements c and f, respectively. In practice, a control-point vector (CPV)-based representation is preferred, since deriving motion vectors is already part of video encoding.

In Ref. [4], a 4-parameter affine model was used to produce the prediction blocks with the two CPVs from the reference area in the current frame. The affine transformation between the reference block and the current block is defined as:

$${mv}^{h} ( x , y ) = CPV {0}^{h} + \frac{CPV {1}^{h} - CPV {0}^{h}}{BlkWidth} \cdot x - \frac{CPV {1}^{v} - CPV {0}^{v}}{BlkWidth} \cdot y \qquad ( 1 )$$

$${mv}^{v} ( x , y ) = CPV {0}^{v} + \frac{CPV {1}^{v} - CPV {0}^{v}}{BlkWidth} \cdot x - \frac{CPV {1}^{h} - CPV {0}^{h}}{BlkWidth} \cdot y$$

where CPV0^{h}, CPV0^{v}, CPV1^{h}, CPV1^{v} are the horizontal and vertical components of the two control point vectors, denoted as CPV0 and CPV1, respectively, and Blkwidth denotes the width of the current block. The motion vector mv (x, y) represents the displacement between the pixel in location x, y in the current block, and the corresponding reference pixel in the affine-transformed block. Compared to affine inter prediction, the proposed affine model restricts motion compensation to integer-pel block vectors. Thus, each block vector derived from eq. (1) is rounded to the nearest integer value.

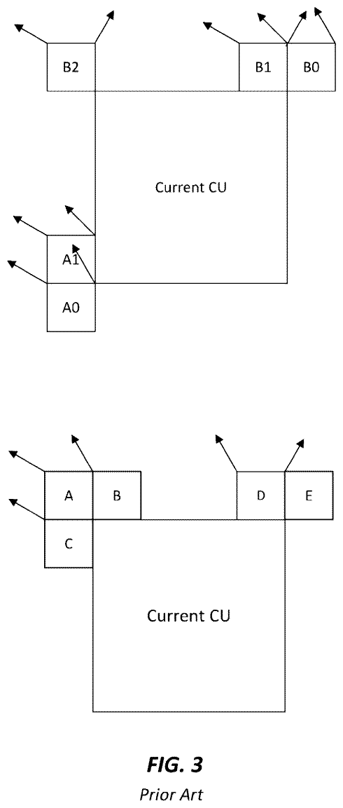

Due to limitations of decoder complexity as well as buffering and throughput requirements, in Ref. [4], as illustrated in FIG. 2, it is proposed to apply a subblock-based affine model, similar as affine for inter prediction in VVC. The current block is split into an array of smaller (e.g., 4×4) subblocks. For each subblock, all samples are predicted with the same block vector, derived from Eq. (1) at the subblock center.

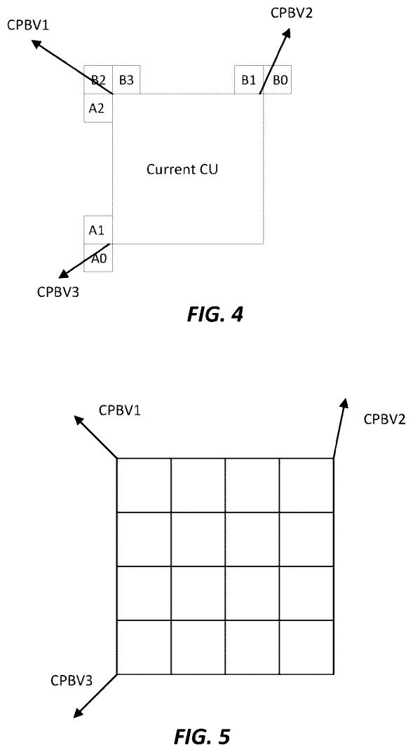

In terms of signaling, a coding unit (CU)-level IBC flag is signaled to indicate whether a block is IBC-coded. When IBC is enabled, an affine flag is further signaled to determine whether an IBC-coded block uses the proposed affine model or not. In case the block is affine-coded, two CPVs are signaled in the bitstream to derive the subblock block vectors. To reduce the signaling overhead for CPV coding, a motion vector prediction (MVP) process is designed for IBC affine-coded blocks, as illustrated in FIG. 3. A list of two MVP candidates are constructed with the following steps:
1) Check whether the neighboring blocks are IBC affine-coded. Block A0 and A1 are checked to extract one MVP candidate; block B0, B1 and B2 are checked to obtain another MVP candidate.
2) In case there is space available in the MVP list, check whether the neighboring blocks are IBC-coded. Block A, B, C are checked to obtain MVP for CPV0; block D, E are checked to obtain MVP for CPV1.
3) Zero vectors are used to fill any remaining space in the MVP list.

Instead of directly coding CPV components, a flag is signaled to indicate which MVP in the list is used. The CPV differences are computed and coded in the bitstream with adaptive motion vector resolution (AMVR), similarly as coding motion vector coding differences (MVD) in inter blocks.

To reduce encoder complexity, Ref. [4] proposed a method to efficiently reduce the number of tested CPV candidates with the following aspects:
1) Restrict the search range within the reconstructed area with a few neighboring coding tree units (CTUs) and the current CTU.
2) The best N CPVs based on prediction distortion (SAD) are stored and ordered in a CPV candidate list.
3) Inherit CPVs from affine-coded neighboring blocks and block vectors from IBC-coded neighboring blocks.
4) Additional process to refine the CPVs based on the gradient of the reference samples.

The proposed IBC-Affine algorithm in Ref. [4] shows significant benefits with an average bitrate reduction by around 2% for screen content including Class F, text and graphic with motion (TGM), and Mixed content, as described in the JVET standard dynamic range (SDR) common test conditions (Ref. [5]).

### Advanced Intra Affine

Example embodiments presented herein propose improved Intra Affine prediction methods for both screen content and nature content.

Intra Affine with Control Point BVs Derived Using Spatial Neighbors.

In an embodiment, consider FIG. 4 showing the current CU and its neighbor spatial locations to derive the control point block vectors (CPBVs). The block vector information for the control points is derived from the specified spatial neighbors. CPBVk (k=1, 2, 3) represents the k-th control point. For CPBV1, the B2, B3, and A2 blocks are checked sequentially. For CPBV2, the B1 and B0 blocks are checked sequentially, and for CPBV3, the A1 and A0 blocks are checked sequentially.

As used herein, spatial neighbor blocks are considered ‘available’ when they had been coded as either an IBC block, an Intra TMP block, or an IntraAffine block, otherwise they are considered as not available. Block vectors from the available spatial neighbors are used as control points. Unlike Ref. [4], this block vector precision can be integer or sub-pixel (say ½, ¼, ⅛, or 1/16 pel).

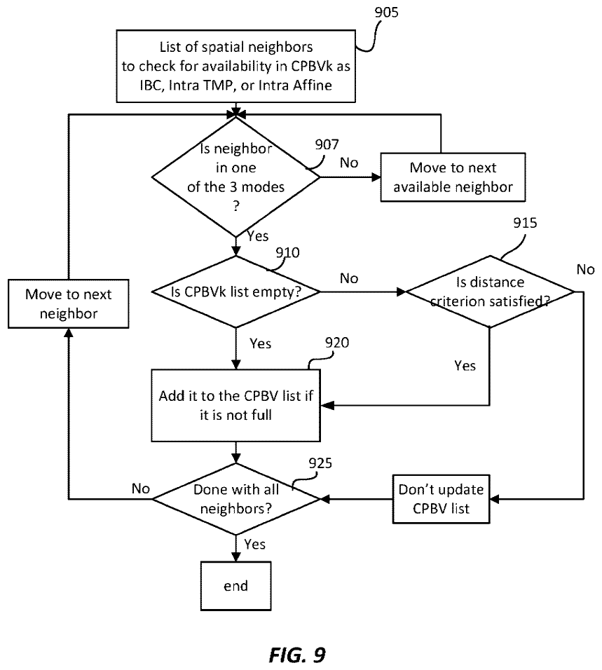

As an example of the construction process, consider the flow diagram in FIG. 9. As depicted in FIG. 9, in steps 905, for each control point, a list of spatial neighbors (as depicted in FIG. 4), will be checked for availability in step 907. For example:
For CPBV1, check: B2 first, then B3, then A2.
For CPBV2, check B1 first, then B0
For CPBV3, check A1 first, then A0

In Inter affine, one picks the first available block as control point. That is, when a neighbor is available, (say B2 for CPBV1) the control point is added to the list, and then the remaining possible neighbors (say, B3 and A2) are skipped and the process continues with the next control point (CPBV2).

In an embodiment, instead of picking the first available block for each control point, all the block vectors from the spatial neighbors can be considered for construction of the CPBV list, provided the block vector differences (or the block vector distance) satisfies a threshold criterion, and the number of best vectors don't exceed a predefined maximum, say 2 or 3 candidates. Thus, as depicted in FIG. 9, in step 910, if in step 907 a neighbor is available, if the list is empty, the neighbor BV is added to the list (920); however, instead of exiting to determine the next control point (as in Inter affine), if there is another neighbor available (step 925), the process returns back to step 907. If the list is not empty, then the process continues to step 915, to determine whether the distance criterion for the distance between the new best vector and the prior vector in the CPBV list is satisfied. If the distance criterion is satisfied, and the CPBV list is not full, then the new BV is added to the list (920), otherwise the BV is discarded, and one moves to the next neighbor (if any is available).

For example, consider the top left neighbors. Say, B2 is available, then it is added to the CPBV1 list. Next, either B3 or A2 is added to the list only if the distance threshold criterion is satisfied. In an embodiment, an example distance criterion computes if the sum of absolute value differences of (B2 bv^{h}−B1 bv^{h}) and (B2 bv^{v}−B1 bv^{v}) is greater than a threshold th (say, th=4 or 8 in integer block vector precision), e.g., for B3:
if |B2 bv^{h}−B3 bv^{h}|+|(B2 bv^{v}−B3 bv^{v})|>th
   then add B3 bv in the CPBV1 list
else don't add B3 bv in the list

If B3 bv is not added, but A2 bv is available, then the distance test process just described will be repeated but with B3 bv replaced with A2 bv. If B3 bv is added, then CPBV1 has already two best vectors, so if the maximum number of candidates is 2, then the CPBV1 list is full, and the process ends. But if the maximum number of candidates is 3, then the distance test can be repeated between the B3 by and the A2 bv to determine whether to add the A2 by into the CPBV1 list.

In essence, this distance criterion tries to eliminate candidate BVs that are too close together. A person skilled in the art will appreciate that instead of using a distance criterion based on a sum of absolute values, other distance criteria, such as mean-square-error and the like, could also be applied.

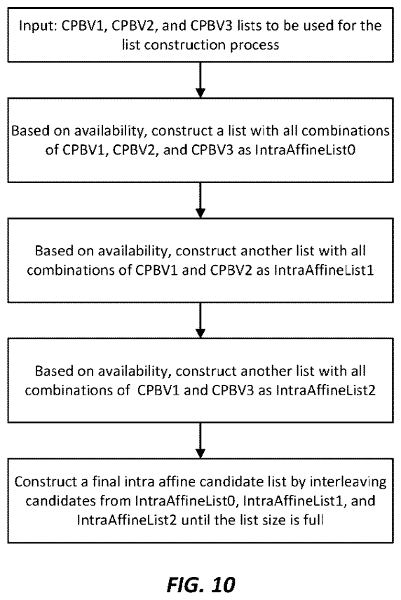

As depicted in FIG. 10, the following combinations of control point BVs are used to construct a final intra affine candidate list: {CPBV1, CPBV2, CPBV3} (IntraAffineList0), {CPBV1, CPBV2} IntraAffine (List1), and {CPBV1, CPBV3} (IntraAffineList2)}. The combination of three CPBVs can be used to construct a 6-parameter affine candidate, while the combination of two CPBVs can be used to construct a 2-parameter affine candidate. If the maximum number of candidates is 2, IntraAffineList0 will create combinations out of 6 possible best vectors, and IntraAffineList1 and IntraAffineList2 will create combinations out of 4 possible best vectors. Finally, given these three lists, the final intra affine list is created by interleaving candidates from all three lists until the list size is full (say, with up to 6 or 8 possible candidates).

For example, consider the three lists:
CPBV1: {B2, B3}
CPBV2: {B1}
CPBV2: {A1, A0}
   Then, one can construct {CPBV1, CPBV2, CPBV3}={{B2,B1,A1}, {B2,B1,A0}, {B3,B1,A0}, {B3,B1,A1}}.

In another embodiment, only a two-control point block vector combination {{CPBV1, CPBV2}, and {CPBV1, CPBV3}} can be considered to reduce the computation and signaling cost.

To simplify the list construction, only a subset of CPBV combinations can be allowed with the list size restricted to a fixed value (say top 4 or 8). In an embodiment, the value of syntax parameter CandIdx corresponds to the best CPBV combination from the final intra affine list, which is selected after evaluation on the encoder side according to some R-D criterion, and it is signaled to the decoder.

FIG. 5 shows the sub-block-based block vector derivation for the current block. Sub-block sizes can be M×N (e.g., 4×4, 8×4, and the like). Each sub-block vector is derived using an affine model and the block vector precision can be at sub-pixel resolution (say 1/16-pel). For example, the block vector of a sub-block at (0,4) is represented as bv(0,4)=bv^{h}(0,4), bv^{v}(0,4), where bv^{h}, bv^{v} are derived from the models. In general, any block vector either at block or sub-block level is used to locate the top-left corner of the reference block/sub-block to predict the current block/sub-block.

The combination of three CPBVs constructs a 6-parameter affine candidate and the combination of two CPBVs constructs a 4-parameter affine candidate. For example {CPBV1, CPBV2, CPBV3} uses the following 6-parameter affine model.

$${bv}^{h} ( x , y ) = CPBV {1}^{h} + \frac{CPBV {2}^{h} - CPBV {1}^{h}}{BlkWidth} \cdot x + \frac{CPBV {3}^{h} - CPBV {1}^{h}}{BlkHeight} \cdot y \qquad ( 2 )$$

$${bv}^{v} ( x , y ) = CPBV {1}^{v} + \frac{CPBV {2}^{v} - CPBV {1}^{v}}{BlkWidth} \cdot x + \frac{CPBV {3}^{v} - CPBV {1}^{v}}{BlkHeight} \cdot y$$

$$\{ CPBV 1 , CPBV 2 \} uses the following 4 - parameter affine model .$$

$${bv}^{v} ( x , y ) = CPBV {1}^{h} + \frac{CPBV {2}^{h} - CPBV {1}^{h}}{BlkWidth} \cdot x + \frac{CPBV {1}^{v} - CPBV {2}^{v}}{BlkWidth} \cdot y \qquad ( 3 )$$

$${bv}^{v} ( x , y ) = CPBV {1}^{v} + \frac{CPBV {2}^{v} - CPBV {1}^{v}}{BlkWidth} \cdot x + \frac{CPBV {2}^{h} - CPBV {1}^{h}}{BlkWidth} \cdot y$$

$$\{ CPBV 1 , CPBV 3 \} uses the following 4 - parameter affine model .$$

$${bv}^{h} ( x , y ) = CPBV {1}^{h} + \frac{CPBV {3}^{h} - CPBV {1}^{h}}{BlkHeight} \cdot y + \frac{CPVB {3}^{v} - CPBV {1}^{v}}{BlkHeight} \cdot x \qquad ( 4 )$$

$${bv}^{v} ( x , y ) = CPBV {1}^{v} + \frac{CPBV {3}^{h} - CPBV {1}^{h}}{BlkHeight} \cdot y + \frac{CPVB {1}^{h} - CPBV {3}^{h}}{BlkHeight} \cdot x$$

As an example, using pseudocode, example syntax for communicating Intra Affine information to a decoder may be of the form:

Example Syntax

```
if(IBC flag)
{
  Signal IntraAffineFlag; //intra affine mode is used
  If(IntraAffineFlag)
  {
    Signal CandIdx;
  }
}
```

where CandIdx denotes the index of the best candidate CPBVs.

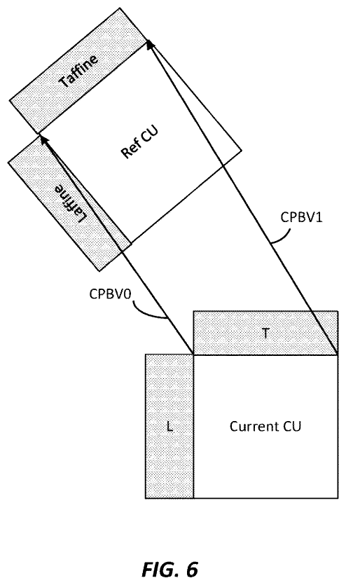

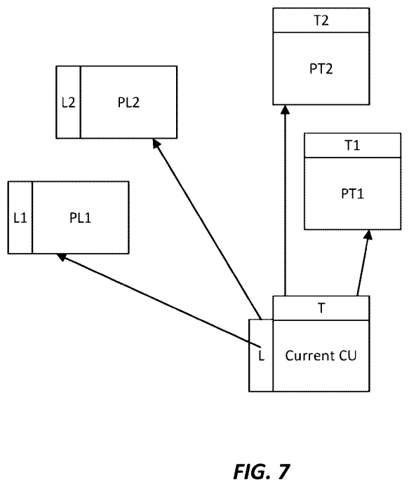

In another embodiment, CandIdx signaling can be avoided using the template matching (TM) technique. FIG. 6 depicts the templates (L,T) and (Laffine, Taffine) for the current and reference blocks for the 4-parameter affine model, defined using two CPBVs. In such a scenario:
Obtain the template region of the predicted block Taffine and Laffine using the affine model and compute the TM cost with respect to T and L of the current block. For example, the TM cost may be computed as the sum of absolute differences (SAD) between T and Taffine+SAD between L and Laffine. The candidate with the lowest TM cost from the affine-candidate list will be picked for affine modeling of the current intra affine block.

For example, a Taffine predicted block with template size of T and sub-block size of N can be derived using an affine model (using equations (2), (3), or (4) based on the CandIdx) with sub-block coordinates as (0,−T), (N,−T), (2N,−T) . . . (CuWidth−N,−T). Similarly, an Laffine predicted block with template size of T and sub-block size of N can be derived using affine model (using equations (2), (3), or (4) based on CandIdx) with sub-block coordinates as

(−T,0), (−T,N), (−T,2N) . . . , (−T, CuHeight−N). For example, template size T can be 4 and Sub-block size N can be 4.

The final affine block vectors with sub pixel precision (say at 1/16 pel) at the sub-block level may be stored such that future coding units with IBC or Intra Affine can use this information as a spatial neighbor candidate.

Block vectors used for the control points as well as the output block vectors from the affine model can be in sub-pixel precision. An interpolation filter, as being used in inter affine can be reused in intra affine to harmonize the design.

In another embodiment, an affine control point block vector search is performed to get better affine control points to improve the intra affine prediction. For example, the control point block vector search process can use a gradient descent algorithm to find a minimum of a cost function representing the difference of current and predicted pixels. This method needs to signal the CandIdx (using intra affine candidate list) and the CPVD (control point vector differences) of control points as discussed earlier.

A CPV difference of two control points can be computed as
CPVD0=CPV0−BVP0, and
CPVD1=CPV1−BVP1−CPVD0,
   where BVP0 and BVP1 are the block vector predictors of CPV0 and CPV1. The generated CPVDs can be signaled in ¼ pel, integer pel, or 4-pel precision.

In another embodiment, positions of the CPVs in the affine field are chosen such that CPVDs are kept minimum. Instead of using block-based positions like (−1,−1), (Block Width−1,−1), and (−1, Block Height−1), positions like (−1,−1), (3,−1), and (−1, 3) can be used where the control point vectors at (3,−1) and (−1,3) are derived using the affine model with block-based positions on both the encoder and the decoder side.

In another embodiment, when signaling the BVD, only the prefix is signaled. Along with the prefix, an aggregate index is signaled which indexes into a suffix predictor list for each CPV and for each component of the CPV. The residual between the actual suffix and the predicted suffix is then signaled. The suffix predictor list is derived in both the encoder and the decoder using the prefix.

Intra Affine with Control Point BVs Derived Using Template Matching.

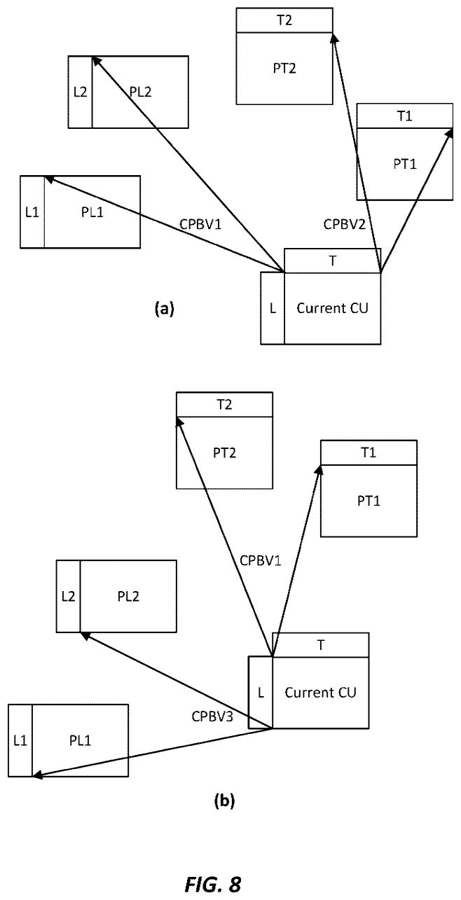

In another embodiment, control point block vectors can be derived using template matching instead of using the spatial neighbors. FIG. 7 shows the current CU along with current template regions L and T. To derive the CPBVs:
Perform template matching on the reference region and get two lists of block vectors. One list of block vectors containing the candidates corresponding to the lowest left template cost, for example L1, L2 . . . . Ln, listed in increasing cost order (with L1 being the minimum cost) as indicated in FIG. 7. Another list of block vectors containing the candidates corresponding to the lowest top template cost, for example T1, T2 . . . . Tn, listed in increasing cost order (with T1 being the minimum cost), as indicated in FIG. 7, where “n” is the maximum size of the list allowed (e.g., 5>n>2). Note that the TM cost of L1 is less than the TM cost of L2, which is less than the TM cost of L3, and so forth, and similarly the TM cost of T1 is less than the TM cost of T2, which is less than the TM cost of T3, and so forth.

In an embodiment, for simplicity, but without limitation, as illustrated in FIG. 8, only two templates (top and left), and only a 4-parameter affine model are considered. There are two cases with different model types. In one case, as in FIG. 8(a), CPBV1 is mapped to the list of candidate blocks corresponding to the lowest left template cost (e.g., L1, L2, . . . , Ln) and CPBV2 is mapped to the list of candidate blocks corresponding to the lowest top template cost (e.g., T1, T2, . . . , Tn) where the affine model from equation (3) is used. In another case, as in FIG. 8(b), CPBV1 is mapped to the list of candidate blocks corresponding to the lowest top template cost (e.g., T1, T2, . . . , Tn) and CPBV3 is mapped to the list of candidate blocks corresponding to the lowest left template cost (e.g., L1, L2, . . . , Ln) where the affine model from equation (4) is used. This method needs to be signaled as a model type, say top model (eq. (3)) or left model (eq. (4)).

In such an embodiment, the final intra affine candidate list is constructed using the combination of left and top template block vector candidates, and CandIdx corresponds to the best CPBV combination from the list as selected after evaluation on the encoder side and signaled to the decoder.

Syntax

```
if(IntraTMP flag)
{
  Signal IntraAffineFlag;
  If(IntraAffineFlag)
  {
    Signal modelType;
    Signal CandIdx;
  }
}
```

where ModelType denotes the type of affine transform model (e.g., top model with eq. (3) or left model with eq. (4)). As discussed earlier, one may apply template matching techniques to avoid signaling the CandIdx value.

In another embodiment, signaling of the affine model type can also be avoided by using template matching. TM cost (top template cost+left template cost) of top model with eq. (3) denoted as TopModCost, and TM cost of left model with eq. (4) denoted as LeftModCost, are compared. The model type (“top” or “left”) corresponding to the lower cost is selected.

The final affine block vectors at sub-block level are stored such that future coding units with IBC or Intra Affine can use this information as a spatial neighbor candidate.

Block vectors used for the control points as well as the output block vectors from the affine model can be in sub-pixel precision. An interpolation filter, as being used in inter Affine can be reused in intra affine to harmonize the design.

In another embodiment, a fusion technique can be applied to reduce the encoder side rate-distortion (RD) checks for all candidate CPBV pairs of each affine model type (e.g., the top or left model). More specifically, for a 4-parameter affine model with two control points, as illustrated in FIG. 8, suppose there are two template matching BV candidates derived from the top template and denoted as T1, T2, and two template matching BV candidates derived from the left template and denoted as L1, L2. For the affine top model with equation (3), the candidate CPBV pairs {CPBV1, CPBV2} are formed by {L1, T1}, {L1, T2}, {L2, T1}, {L2, T2}. Similarly, for the affine left model with equation (4), the candidate CPBV pairs {CPBV1, CPBV3} are formed by {T1, L1}, {T1, L2}, {T2, L1}, {T2, L2}. Instead of applying RD checks for all eight candidate CPBV pairs, for each affine model (top or left), fusion is first applied to calculate the average value of the prediction samples derived from four candidate CPBV pairs, as illustrated in equations (5) and (6). Then two RD checks are applied on the fused prediction samples, one for the affine top model and one for the left model, to decide which model to be used. For the affine top model,

Fused Pred=¼*{Pred(L1,T1)+Pred(L1,T2)+Pred(L2,T1)+Pred(L2,T2)}, (5)

where Pred(Li, Tj) denotes the prediction sample derived from the affine top model with CPBV pairs corresponding to Li and Tj, i=1 or 2, and j=1 or 2.

For the affine left model,

Fused Pred==*{Pred(T1,L1)+Pred(T1,L2)+Pred(T2,L1)+Pred(T2,L2)}, (6)

where Pred(Ti, Lj) represents the prediction sample derived from the affine left model with CPBV pairs corresponding to Ti and Lj, i=1 or 2, and j=1 or 2.

In another embodiment, a fusion process can be applied after the affine model selection. For the 4-parameter affine model with two control points, as illustrated in FIG. 8, first use the best matching BV with the lowest TM costs for the top template and the left template (T1 and L1) to form the reference CPBV pairs {L1, T1} for the affine top model, and {T1, L1} for the affine left model. The encoder applies RD checks on {L1, T1} and {T1, L1} to decide which model to be used. Then fusion is applied to calculate the average value of the prediction samples {P1, P2, P3, P4} derived from the four candidate CPBV pairs respectively corresponding to the selected affine model (top or left).

Fused Pred=¼*(P1+P2+P3+P4) (7)

For example, suppose the top model is selected, then one may use the affine model defined in equation (3) to compute the BV pointing to the corresponding block, and use samples in the corresponding bock to predict pixels in the current CU. Let P1-P4 represent the prediction values derived using the affine model with CPBV pairs {L1, T1}, {L1, T2}, {L2, T1}, and {L2, T2}, respectively. The process is similar when selecting the affine left model case.

In another embodiment, for the two fusion methods discussed earlier (e.g., related to equations (5)-(7)), instead of computing the average value of the prediction samples derived from the four candidate CPBV pairs, adaptive weights based on template matching cost can be used to derive the weighted sum of the prediction samples P1 to P4. Suppose the TM cost for each block is denoted as Cost T1, Cost T2 for two candidates from the top template, and Cost L1, Cost L2 for two candidates from the left template, then the combined cost of each CPBV pair is calculated as the sum of the cost of each CPBV candidate. Denote the prediction samples derived from the four candidate CPBV pairs as {P1, P2, P3, P4}, then the weights may be calculated as follows,

$$sum = {\sum }_{i = 1}^{n} {SAD}_{1} , \qquad ( 8 )$$

$${w}_{1} = \frac{sum - {SAD}_{i}}{( n - 1 ) + sum} , \qquad ( 9 )$$

where for the affine top model,
SAD1=CostL1+CostT1,
SAD2=CostL1+CostT2,
SAD3=CostL2+CostT1, and
SAD4=CostL2+CostT2.
   For the affine left model,
SAD1=CostT1+CostL1,
SAD2=CostT1+CostL2,
SAD3=CostT2+CostT1, and
SAD4=CostT2+CostL2.
   Then, the final fused predictor may be determined by,

$${P}_{fusion} = {\sum }_{i = 1}^{n} {w}_{i} {P}_{i} . \qquad ( 10 )$$

In summary, compared to Ref. [4], example embodiments include the following new features:
1. Instead of supporting screen content alone, they support affine transformation for intra prediction for both screen content and nature (camera) content.
2. They support affine transformation for both IBC mode and Intra TMP mode.
3. Using spatial neighbors, they support fractional block vectors instead of integer-only block vectors.
4. Ref. [4] uses an MVP process where only one candidate from A0 and A1 and then another from B0,B1 and B2 are extracted and then their differences is signaled. In the proposed approaches, BV differences are not signaled. Instead, one uses multiple candidates from spatial neighbors instead of using the first available candidates.
5. They may apply a template matching technique to avoid candidate index signaling
6. A novel fusion scheme for template matching reduces encoder complexity.
   Affine modelled Intra prediction mode field at sub-block level.

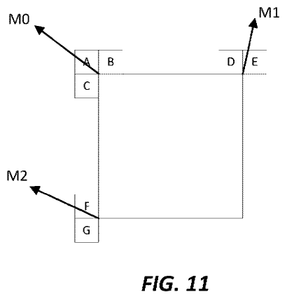

In an embodiment, Intra mode field at sub-block level (for example, a 4×4 or 8×8 level) for a current block can be derived using the affine model by using the control point modes from the spatial neighbours. FIG. 11 depicts the list of neighbour blocks whose intra prediction modes can be used as control points for affine modeling to derive M0 (one of the A, B, or C blocks), M1 (D or E block), and M2 (F or G block). The affine model being used can be either a 4-parameter or 6-parameter model (like equations (2), (3), and (4)). A candidate list containing the combination of control point modes is prepared and the best control point modes are signalled through the candidate list index (CandIdx). The candidate list can be optimized by removing duplicates.

In an embodiment, consider List1 which contains intra prediction modes corresponding to top left blocks in the order of A, B and C, List 2 which contains intra prediction modes corresponding to top right blocks in the order of D and E, and List 3 which contains intra prediction modes corresponding to bottom left blocks in the order of F and G. A candidate list is created using a pair of modes from the list sequentially: {List1, List2}, {List1, List3} and

{List2, List3} for a four-parameter model. Similarly, triples of modes from {List1, List2, List3} can be generated for the six-parameter model. Using the CandIdx and model type (6- or 4-parameters), the control point modes M0, M1 and M2 are selected.

In intra prediction, an angle θ is derived for each spatial neighbor mode. For example, intra mode 34 (from FIG. 9 in Ref. [1]) corresponds to 135 degrees, and intra mode 50 corresponds to 90 degrees. In an embodiment, this control-point angle may be used to derive sub-block level angles using the following equations:

4-parameter model

Cos(θ)(x,y)=ax+by+c (11)

Sin(θ)(x,y)=−bx+ay+f (12)

### 6-Parameter Model

Cos(θ)(x,y)=ax+by+c (13)

Sin(θ)(x,y)=dx+ey+f (14)

where:
a=(cos(angle(M1))−cos(angle(M0)))/blockWidth
b=(cos(angle(M2))−cos(angle(M0)))/blockHeight
c=cos(angle(M0))
d=(sin(angle(M1))−sin(angle(M0)))/block Width
e=(sin(angle(M2))−sin(angle(M0)))/blockHeight
f=sin(angle(M0)),
   where blockHeight and block Width denote the height and width of the CU.
   Then, sub-block modes are derived as:

$$Mode m ( x , y ) = a tan ( \frac{Sin ( θ ) ( x , y )}{Cos ( θ ) ( x , y )} ) , \qquad ( 15 )$$

where Cos(θ)(x,y) and Sin(θ)(x,y) are the cosine and sine values of the sub-block angles at position x and y.

In an embodiment, one may use these sub-block modes to compute the intra prediction at sub-block level using only the reconstruction samples at the CU boundary as reference. In another embodiment, inner sub-block with CUs can use the previous prediction sample from the neighbor sub-blocks.

In another embodiment, an encoder can perform a search to get the best control point intra prediction modes instead of using spatial neighbors. In this case, the control point intra prediction mode index and a delta parameter have to be signaled.

The affine modelled intra prediction mode field helps to code the block using sub-block intra prediction without signaling sub-block intra prediction modes. In this method sub-block intra prediction modes are derived implicitly using control point modes using affine model.

### REFERENCES

Each one of the references listed herein is incorporated by reference in its entirety. The term JVET refers to the Joint Video Experts Team of ITU-T SG 16 WP 3 and ISO/IEC JTC 1/SC 29.
[1] “Versatile Video Coding,” Rec. ITU-T H.266, August 2020.
[2] M. Coban, et al., “Algorithm description of Enhanced Compression Model 9 (ECM 8),” JVET-AC2025, 29-th meeting, by teleconference, January 2023.
[3] X. Xu, et al., “Intra block copy in HEVC screen content coding extensions,” IEEE Journal on Emerging and Selected Topics in Circuits and Systems, vol. 6, no. 4, pp. 409-419, December 2016.
[4] J. Adhuran, et al., “Affine Intra-prediction for Versatile Video Coding,” 2020 28th European Signal Processing Conference (EUSIPCO), Amsterdam, Netherlands, 2021, pp. 545-549, doi: 10.23919/Eusipco47968.2020.9287579.
[5] F. Bossen, et al., “VTM common test conditions and software reference configurations for SDR video,” JVET-T2010, 20-th meeting, by teleconference, October 2020.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to applying intra affine prediction tools in image and video coding, such as those described herein. The computer and/or IC may compute any of a variety of parameters or values that relate to applying intra affine prediction tools in image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to applying intra affine prediction tools in image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to applying intra affine prediction coding tools in image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1-3. (canceled)

4. A method for video decoding intra-coded coding units coded in an intra affine mode, the method comprising:
receiving a coded unit (CU) coded using an intra-affine prediction mode;
determining two control point best vectors (CPBVs) based on a list of best vectors (BVs) generated from a template matching process;
determining motion vectors for the intra-affine prediction mode based on the two CPBVs; and
decoding the CU using the determined motion vectors, wherein determining the two control point best vectors (CPBVs) comprises:
for a first CPBV of the two CPBVs creating a first BV list of two or more best vectors based on template costs using a left or a top template for the CU; and
for a second CPBV of the two CPBVs creating a second BV list of two or more best vectors based on template costs using a top or a left template for the CU.

5. The method of claim 4, wherein creating the first BV list comprises:
computing template costs associated with performing template matching (TM) between the left template for the CU and two or more corresponding templates in a reference region for the CU;
ranking the template costs in increasing cost order; and
selecting as BVs vectors for the first BV list those vectors associated with two or more of the template costs with smaller template costs.

6. The method of claim 4, wherein creating the second BV list comprises:
computing template costs associated with performing template matching (TM) between the top template for the CU and two or more corresponding templates in a reference region for the CU;
ranking the template costs in increasing cost order; and
selecting as BVs vectors for the second BV list those vectors associated with two or more of the templates costs with smaller template costs.

7. The method of claim 4 wherein a syntax parameter received by the decoder determines whether the first BV list is associated with the left template and the second BV list is associated with the top template or whether the first BV list is associated with the top template and the second BV list is associated with the left template.

8. The method of claim 1 or claim 4, wherein determining the two or more CPBVs further comprises:
generating based on the BV lists for the two or more CPBVs a final intra affine candidate list; and
selecting according to a selection criterion the two or more CPBVs.

9. The method of claim 8, wherein the selection criterion comprises receiving a candidate index parameter from the decoder selecting the two or more CPBVs in the final intra affine candidate list.

10. The method of claim 9, wherein the selection criterion comprises performing template matching between the CU and candidate CPBVs in the final intra affine candidate list and selecting the two or more CPBVs with the smaller template-matching cost.

11-13. (canceled)

14. A method for video encoding coding units in an intra affine mode, the method comprising:
accessing a coded unit (CU) to be coded in intra-affine prediction mode;
determining two control point best vectors (CPBVs) based on a list of best vectors (BVs) generated from a template matching process;
determining motion vectors for the intra-affine prediction mode based on the two CPBVs; and
encoding the CU using the determined motion vectors, wherein determining the two control point best vectors (CPBVs) comprises:
for a first CPBV of the two CPBVs creating a first BV list of two or more best vectors based on template costs using a left or a top template for the CU; and
for a second CPBV of the two CPBVs creating a second BV list two or more best vectors based on template costs using a top or a left template for the CU.

15. The method of claim 14, wherein creating the first BV list comprises:
computing template costs associated with performing template matching (TM) between the left template for the CU and two or more corresponding templates in a reference region for the CU;
ranking the template costs in increasing cost order; and
selecting as BVs vectors for the first BV list those vectors associated with two or more of the templates costs with the smaller template costs.

16. The method of claim 14, wherein creating the second BV list comprises:
computing template costs associated with performing template matching (TM) between the top template for the CU and two or more corresponding templates in a reference region for the CU;
ranking the template costs in increasing cost order; and
selecting as BVs vectors for the second BV list those vectors associated with two or more of the templates costs with the smaller template costs.

17. The method of claim 14, wherein a syntax parameter transmitted by the encoder in a bitstream with the encoded CU specifies whether the first BV list is associated with the left template and the second BV list is associated with the top template or whether the first BV list is associated with the top template and the second BV list is associated with the left template.

18. The method of claim 14, wherein determining the two or more CPBVs further comprises:
generating based on the BV lists for the two or more CPBVs a final intra affine candidate list; and
selecting according to a selection criterion the two or more CPBVs.

19. The method of claim 18, wherein the selection criterion comprises selecting the two or more CPBVs according to a rate-distortion criterion, and sending by the encoder a candidate index parameter identifying the two or more CPBVs in the final intra affine candidate list.

20. The method of claim 19, wherein the selection criterion comprises performing template matching between the CU and candidate CPBVs in the final intra affine candidate list and selecting the two or more CPBVs with the smaller template-matching costs.

21. (canceled)

22. A method in an encoder for video coding intra-coded coding units coded in an intra affine mode, the method comprising:
accessing a coded unit (CU) to be coded in intra-affine prediction mode;
performing an affine block vector search to determine two control point vectors (CPV0, CPV1) and two block vector predictor indices (BVP0, BVP1); and
signaling to a decoder two control point vector differences (CPVD0, CPVD1), where:
CPVD0=CPV0−BVP0, and
CPVD1=CPV1−BVP1−CPVD0,
wherein the two block vector predictor indices are derived using a candidate index (CandIdx) signaled for a candidate list constructed using block vectors from blocks neighboring to the CU.

23-25. (canceled)

26. A method for intra-mode encoding at a sub-block level, the method comprising:
accessing a coded unit (CU);
accessing blocks A, B, and C neighboring a top left corner of the CU;
accessing blocks F and G neighboring a bottom left corner of the CU;
accessing block D and E neighboring a top right corner of the CU;
generating List1 comprising intra prediction modes for the A, B, and C neighboring blocks;
generating List2 comprising intra prediction modes for the F and G neighboring blocks;
generating List3 comprising intra prediction modes for the D and E neighboring blocks;
generating a candidate list with pairs of candidate intra prediction modes based on {List1, List2}, {List1,List3} and {List 2, List 3} for a four-parameter affine model or a set of candidate intra prediction modes based on {List1, List2, List3} for a six-parameter model;
generating a candidate index (CandIdx) pointing to a candidate list of control point best vectors for blocks M0, M1, and M2 neighboring the CU and minimizing coding cost according to a rate-distortion criterion;
and signaling the candidate index to a decoder.

27. The method of claim 26, further comprising:
determining angle(M0), angle(M1), and angle(M2) based on the intra mode of blocks M0, M1, and M2;
computing Sin(θ)(x,y) and Cos(θ)(x,y) according to a parameter model based on angle(M0), angle(M1), and angle(M2); and
generating an intra mode for sub-block positioned at (x,y) as
$$Mode m ( x , y ) = a tan ( \frac{Sin ( θ ) ( x , y )}{Cos ( θ ) ( x , y )} ) .$$

28. The method of claim 17, wherein for a 4-parameter model
Cos(θ)(x,y)=ax+by+c,
Sin(θ)(x,y)=−bx+ay+f,
and for a 6-parameter model
Cos(θ)(x,y)=ax+by+c,
Sin(θ)(x,y)=dx+ey+f,
wherein
a=(cos(angle(M1))−cos(angle(M0)))/blockWidth,
b=(cos(angle(M2))−cos(angle(M0)))/blockHeight,
c=cos(angle(M0)),
d=(sin(angle(M1))−sin(angle(M0)))/blockWidth,
e=(sin(angle(M2))−sin(angle(M0)))/blockHeight,
f=sin(angle(M0)),
and blockHeight and blockWidth denote height and width of the CU.

29-30. (canceled)
